(19) United States
(12) Patent Application Publication
(10) Pub. No.: US 2024/0135722 A1
(43) Pub. Date: Apr. 25, 2024

(54) METHOD FOR LEVERAGING SHAPE INFORMATION IN FEW-SHOT LEARNING IN ARTIFICIAL NEURAL NETWORKS

(71) Applicant: NavInfo Europe B.V., Eindhoven (NL)

(72) Inventors: Deepan Chakravarthi Padmanabhan, Eindhoven (NL); Shruthi Gowda, Eindhoven (NL); Elahe Arani, Eindhoven (NL); Bahram Zonooz, Eindhoven (NL)

(73) Assignee: NavInfo Europe B.V., Eindhoven (NL)

(21) Appl. No.: 18/165,857

(22) Filed: Feb. 7, 2023

(30) Foreign Application Priority Data
Oct. 10, 2022 (NL) 2033265
Feb. 7, 2023 (NL) 2034110

(51) Int. Cl. G06V 20/58; G06V 10/82; G06V 20/40

(52) U.S. Cl. CPC G06V 20/58; G06V 10/82; G06V 20/41; G06V 2201/07

(57) ABSTRACT

A computer-implemented method that provides a novel shape aware FSL framework, referred to as LSFSL. In addition to the inductive biases associated with deep learning models, the method of the current invention introduces meaningful shape bias. The method of the current invention comprises the step of capturing the human behavior of recognizing objects by utilizing shape information. The shape information is distilled to address the texture bias of CNN-based models. During training, the model has two branches: RIN-branch, network with colored images as input, preferably RGB images, and SIN-branch, network with shape semantic-based input. Each branch incorporates a CNN backbone followed by a fully connected layer performing classification. RIN-branch and SIN-branch receive the RGB input image and shape information enhanced RGB input image, respectively. The training objective is to improve the classification performance of the RIN-branch and SIN-branch as well as to distill shape semantics from SIN-branch to RIN-branch. The features of the RIN-branch and SIN-branch are aligned to distill shape representation into RIN-branch. This feature alignment implicitly achieves a bias-alignment between the RIN and SIN. The learned representations are generic and remain invariant to common attributes.

### CROSS-REFERENCE TO RELATED APPLICATIONS

This application claims priority to and the benefit of Netherlands Patent Application No. 2033265, titled “METHOD FOR LEVERAGING SHAPE INFORMATION IN FEW-SHOT LEARNING IN ARTIFICIAL NEURAL NETWORKS”, filed on Oct. 10, 2022, and Netherlands Patent Application No. 2034110, titled “METHOD FOR LEVERAGING SHAPE INFORMATION IN FEW-SHOT LEARNING IN ARTIFICIAL NEURAL NETWORKS”, filed on Feb. 7, 2023, and the specification and claims thereof are incorporated herein by reference.

### BACKGROUND OF THE INVENTION

### Field of the Invention

The invention relates to a computer-implemented method for Leveraging Shape Information in Few-shot Learning (FSL) in artificial neural networks for enriching the performance of any Convolutional Neural Network-based (CNN) few-shot learning model.

Few-Shot Learning is an example of meta-learning, where a learner is trained on several related tasks, during the meta-training phase, so that it can generalize well to unseen (but related) tasks with just a few examples, during the meta-testing phase. Few-shot training stands in contrast to traditional methods of training machine learning models, where a large amount of training data is typically used. Few-shot learning is used primarily in Computer Vision. In other terms, few-shot learning is the approach of making predictions based on a limited number of samples. The goal of few-shot learning is not to let the model recognize the images in the training set and then generalize to the test set. Instead, the goal is “Learn to learn”.

### Background Art

Humans learn to identify new objects from substantially fewer data, while machine learning models require a lot of data. Annotating enormous data is expensive in terms of time and human effort. In real-world scenarios, there is no access to multiple samples of the same class. The machine learning model must adapt and learn quickly using fewer samples. For example, annotating numerous objects to train a recognition model for autonomous driving applications under varying climatic conditions is highly challenging. To address these challenges, few-shot learning techniques aid in developing artificial intelligence (AI) models with the ability to generalize well on novel unseen examples using only a few samples.

Human visual system relies on global semantics such as shape information to recognize objects. However, Deep Neural Networks (DNN) majorly rely on local as well as trivial cues rather than global features. This attention to trivial cues serves as a shortcut during the learning stage. The shortcut learning biases the network to highly rely on local texture information as well as unintended spurious patterns for decision making. This considerably affects model generalization as well as robustness. With many state-of-the-art Few-shot Learning (FSL) models being CNN-based, the network is vulnerable to shortcut learning and susceptible to relying more on texture information [1]. Even though in standard classification setup, texture bias of CNNs aids in improving accuracy, in FSL the texture bias substantially affects the generalization [3]. The challenges in the few-shot setting such as distributional shift between train and test set [2], the lesser data scenario, and model overfitting to the fewer data aggravate the effects of texture bias. The model loses the ability to robustly generalize to novel few-shot classes. These challenges further increase the need for models that are less vulnerable to shortcuts and spurious patterns. On the other hand, humans look at global abstractions such as shape information to recognize objects. Various studies explore the utility of shape by infants and adults [1] to recognize objects. In the standard supervised learning setup with numerous annotated data, incorporating shape information into the backbone addresses the increased texture bias of CNNs [20]. The resulting model illustrates improved generalization as well as robustness to adversarial perturbations. In addition to the inductive biases of CNN, a shape bias is introduced in the few-shot learning setup to capture the human behavior of recognizing objects using global shape semantics. The method of the current invention comprises the step of forcing the network to concentrate on the implicit global shape information and produce better generic high-level representations. The learned global features help in improving the few-shot generalization and the network is less susceptible to overfitting due to limited samples. The methodology can be combined with any CNN-based model to mitigate the shortcut learning issue by incorporating shape information into the feature representations.

Various state-of-the-art FSL models [5] [6] [7] [8] improve performance by enriching the embedding model using knowledge distillation and incorporating certain inductive biases. It is an object of the current invention to enhance the representations learned by the embedding model by distilling shape information into the FSL model. This and other objects which will become apparent from the following disclosure, are provided with a computer-implemented method for continual learning in artificial neural networks, a computer-readable medium, and an autonomous vehicle comprising a data processing system, having the features of one or more of the appended claims.

### Knowledge Distillation in Few-shot Learning:

Rethinking Few-Shot-Distill (RFS-Distill) [7] shifts the focus on developing a good base embedding model to improve FSL. Initially, the method trains a backbone to classify the train set categories. In the second stage, the acquired knowledge is distilled to a new feature extractor. This Born-Again distillation with feature normalization enhances the representations from the backbones up to a certain generation. Invariant and Equivariant Representations (IER-Distill) [6] incorporate both invariance and equivariance inductive biases of certain geometric transformations for few-shot learning. The features are independent of transformations and capture the data structure. IER-Distill employs a multi-head distillation over standard supervised distillation to achieve state-of-the-art results. Liu et al., learn a model for few-shot classification using online self-distillation. The method unifies the two stages of RFS-Distill into one. The student model is updated using stochastic gradient descent (SGD) whereas the teacher model is continuously updated based on the student parameters without backpropagation. In addition, the work identifies CutMix augmentation aids in achieving state-of-the-art performance in various few-shot settings.

The method of the current invention comprises the step of utilizing knowledge distillation between the RGB image-based network (RIN) and the shape image-based network (SIN) to distill shape information in the pretraining stage. Whereas none of the above prior art methods integrate shape information between two networks.

### Overcoming Biases in Few-shot Learning:

The biases affecting the generalization of conventional machine learning problem creates a larger impact in FSL setup. This is primarily due to evaluating FSL models with unseen novel categories. Ringer et al., [3] study the detrimental effect of texture bias illustrated by CNNs in FSL. The paper addresses the texture bias by modifying the training data with non-texture-based and texture-based images. On the other hand, the method of the current invention addresses the susceptibility to texture shortcut by directly incorporating shape information to the backbone in the learning phase.

Similarly, the image background serves as a shortcut in the FSL scenario and impacts the in-class classification performance. [4] mitigates the issue by sampling the foreground as well as the original images at both training and testing phases. The application proposes COSOC, a framework [4] to extract foreground images by focusing on the shared patterns among each class using contrastive learning and k-means clustering. In contrast to the method of the current invention, COSOC focuses on addressing the background shortcut by extracting foreground images.

In FSL, the embedding feature distribution is well-defined for base classes used for training. However, the feature distribution is affected by the domain shift incurred by the novel classes. [2] proposes Distribution Calibration Module (DCM) and Selected Sampling (SS) that mitigates class-agnostic and class-specific bias, respectively, at the meta-test phase. [2] exploits the texture biased features and does not take steps to curb shortcut learning.

### Incorporating Shape Bias:

[5] illustrates the effectiveness of incorporating explicit shape bias for few-shot classification. The work contributes a synthetic 3D object dataset, Toys4K, covering 105 categories with 4179 object instances in total. The training procedure includes learning point cloud and image embeddings from point cloud as well as image data, respectively. DGCNN and ResNet18 with cross-entropy are used to train the embedding models. The evaluation incorporates the nearest centroid classifier of the average of both embeddings to the query image embedding. This method [5] of developing shape-aware FSL models have utilized 3D shape information along with image data to learn an embedding model and construct a Prototype classifier. The additional synthetic point cloud data reduces the applicability of the method [5]. The method of the current invention comprises the step of incorporating the shape bias solely using the shape information in the RGB input image.

This application refers to a number of publications. Such is provided for a more thorough background and is not to be construed that such publications are prior art for purposes of determining patentability.

### BRIEF SUMMARY OF THE INVENTION

According to an embodiment of the present invention, a computer-implemented method for capturing human-like object recognition in an artificial neural network comprises the step of training said network, wherein the step of training the network comprises the step of splitting said network during training into two branches:
a RIN-branch wherein the network receives a colored image as input; and
a SIN-branch wherein the network receives a shape semantic-based image as input,
   wherein the method comprises the step of training the RIN-branch and the SIN-branch in parallel by calculating at least one alignment loss for distilling shape feature representations learned by the SIN-branch into the RIN-branch.

Advantageous embodiments are further defined hereinafter.

The method preferably comprises the step of obtaining the shape semantic-based image by using an edge detection algorithm, such as Sobel edge operator, on the colored image.

The method preferably comprises the step of providing the colored image as an RGB-based image. To be noted that said RGB-based image can be acquired by a camera, a video recorder, a scene recorder or any other type of image capturing device.

The method preferably comprises the steps of incorporating, at each branch, a backbone network for features extraction and a fully connected layer, after said backbone network, for performing classification.

The method preferably comprises the step of configuring the RIN-branch and the SIN-branch as feature extractor networks, such as ResNet12-based classifiers.

The step of calculating at least one alignment loss preferably comprises the step of calculating at least one feature alignment loss for distilling shape feature representations learned by the SIN-branch into the RIN-branch.

Advantageously, the step of calculating the at least one feature alignment loss comprises the step of calculating a mean squared error between feature embeddings of RIN-branch and feature embeddings of SIN-branch.

The step of calculating at least one alignment loss preferably comprises the step of calculating at least one decision alignment loss for aligning decision boundaries of the RIN-branch and the SIN-branch.

Advantageously, the step of calculating the at least one decision alignment loss comprises the step of calculating a relative entropy measure, such as Kullback-Leibler divergence, between activation functions in outputs of the RIN-branch and activation functions in outputs of the SIN-branch.

The method preferably comprises the steps of:
calculating a cross-entropy loss over output of the RIN-branch; and
calculating a cross-entropy loss over output of the SIN-branch.

The method preferably comprises a meta-test training phase, wherein said method comprises the step of training a logistic regression using the features extracted from the RIN-branch and a cross entropy loss.

In a second embodiment of the invention, the computer-readable medium is provided with a computer program wherein when said computer program is loaded and executed by a computer, said computer program causes the computer to carry out the steps of the computer-implemented method according to any one of aforementioned steps.

In a third embodiment of the invention, the autonomous vehicle comprising a data processing system loaded with a computer program wherein said program is arranged for causing the data processing system to carry out the steps of the computer-implemented method according to any one of aforementioned steps for enabling said autonomous vehicle to continually adapt and acquire knowledge from an environment surrounding said autonomous vehicle.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a schematic diagram of a computer-implemented method according to an embodiment of the present invention.

Whenever in the figures the same reference numerals are applied, these numerals refer to the same parts.

### DETAILED DESCRIPTION OF THE INVENTION

Generally, FSL for classification involves two steps: pre-training and meta-testing. In the pre-training step, a model M comprising of a backbone feature extractor fφ and fully-connected layers gΘ is trained on base classes Nb from a base dataset Db=(xi, yi) where i=1, 2, . . . , B. The classification loss function Lp and parameter regularization term [symbol] used to pre-train the model is given by,

$$ℳ = {arg min}_{Φ , Θ} {𝔼}_{{𝒟}_{b}} [ {ℒ}_{p} ( {𝒟}_{b} ; Φ , Θ ) ] + ℛ ( Φ , Θ ) \qquad ( 1 )$$

The pre-training strategy employs meta-learning [21, 22, 23] or standard supervised (non-meta) learning [6, 7] training setup. The meta-testing phase utilizes a dataset Dm with novel unseen classes to the classes in Db. The meta-testing or inference phase includes a series of few-shot tasks with data sampled from Dm. Each task contains a meta-test training and meta-test testing step using the support set S=Dtrain_l where i=1, 2, . . . , N and query set Q=Dtest_i where i=1, 2, . . . , N, respectively. N is the total number of tasks in meta-testing phase. Each support set contains Nf unique novel classes and kf examples per class. Thereby, each few-shot task is represented as Nf-way, kf-shot task.

In meta-test train phase, the pre-trained model M acts as a fixed feature extractor utilizing fφ or fine-tuned by updating certain layers or the entire model in meta-testing. The embeddings from fφ are used to train a simple classifier gθ such as logistic regressor or support vector machine [7]. Additionally in certain cases, the embeddings are classified using non-parametric classifiers like nearest

neighbor by estimating class prototypes [23]. Lm is the loss function of the meta-test phase with parameter regularization [symbol] .

$$Ψ = {arg min}_{Ψ} {𝔼}_{𝒮} [ {ℒ}_{m} ( {𝒟}^{train} ; Ψ ) ] + ℛ ( Ψ ) \qquad ( 2 )$$

where Ψ is given by,

$$Ψ = \{ \begin{matrix}{[ {Φ}^{T} , {θ}^{T} ]}^{T} & if both Φ and θ are trainable \\ [ θ ] & if θ is trainable \\ [ Φ ] & if Φ is trainable\end{matrix} \qquad ( 3 )$$

The overall objective is to minimize the average test error over the distribution of meta-test test set. The query set is sampled from the same distribution as the corresponding support set.

[symbol]

_{Q} [ [symbol] ₘ ( [symbol] ^{test}; Ψ)] (4)

With the use of CNNs in majority of classification tasks [10], the models are prone to learn the local information [24]. This affects generalization substantially even with slightest perturbations, changes in background data, statistical irregularities, or color schemes. This effect is exacerbated further in the few-shot settings as the distribution shift between the training and testing class is more prevalent [3, 25]. This calls for a more robust model for few-shot learning. Unlike CNNs, human visual system is robust and recognizes objects under different conditions using less data. Studies have attributed this human behavior to the cognitive biases of human brain or prior knowledge gathered. The presence of cognitive biases aid in focusing on the global discriminative shape features for recognition [1, 11]. Motivated by this, we propose to impart an additional bias in the form of shape on top of the generic inductive biases of CNNs at the learning stage.

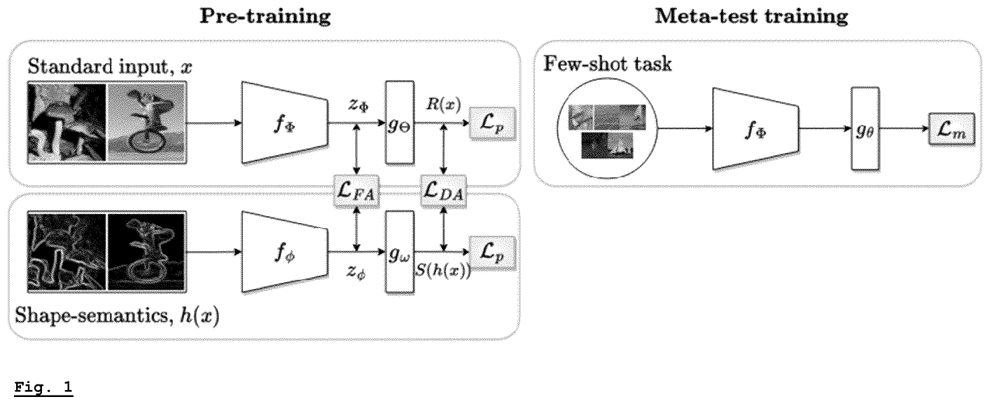

The method of the current invention, called LSFSL, is detailed hereinafter with reference to a preferred embodiment which cannot be deemed restrictive as to the appended claims, and in particular does not require the simultaneous application of all mentioned features. LSFSL embodies a computer-implemented method to develop shape-aware FSL models leveraging the implicit shape information present in an RGB input image. Unlike [5], the method of the current invention does not utilize any additional datasets to develop shape-aware models. The method of the current invention comprises the step of incorporating the shape information into the model during the pre-training stage. The method of the current invention comprises the step of synchronously training two networks: RIN (standard RGB Input Network) and SIN (Shape Input Network) by distilling shape knowledge between the networks [20]. Each network comprises a backbone feature extractor followed by fully-connected layers for classification. SIN network is fed with an image with enhanced shape-semantics to extract the shape information pertaining to the data. To extract the shape information, the method of the current invention comprises the step of employing Sobel edge operator which identifies the shape information through discrete differentiation from the RGB input image in a computationally inexpensive way. As shown in FIG. 1, a standard input image x and an image with shape semantics h(x) is passed to the networks RIN and SIN respectively. The method of the current invention comprises the step of employing two bias alignments to distill shape information from SIN to RIN: backbone feature alignment LFA and decision alignment LDA force RIN to focus on the enhanced shape semantics. This approach of learning the shape information along with the standard biases aids in achieving robust representation in the RIN network by aggregating information from RGB and edge input image.

FIG. 1: The method of the current invention, LSFSL, pipeline illustrating the pre-training and the meta-test training pipeline. The shape bias is incorporated in the pre-training stage to address the few-shot model bias to texture. The shape semantics are obtained by applying a Sobel edge operator on the RGB input image. The meta-testing train stage fits a logistic regressor on the RGB image features from the RIN model.

The feature embeddings from RIN backbone fφ and SIN backbone fφ for a batch of training images x are represented as zφ and zφ, respectively. The Sobel operated shape image is represented as h(x). The bias alignments are bi-directional as noticed SIN requires certain texture information to improve generalization (Equation 6) and the vice-versa distills shape knowledge to RIN (Equation 5).

[symbol]

_{FAR}= [symbol] [∥z_{Φ}−stopgrad(z_{φ})∥₂²] (5)

[symbol]

_{FAS}= [symbol] [∥stopgrad(z_{Φ})−z_{φ}∥₂²] (6)

Therefore, putting Equation 5 and Equation 6 together, a strict alignment of the backbone features of RIN and SIN is accomplished using mean squared error (MSE) as follow,

[symbol]

_{FA}=yᵣ [symbol] _{FAR}+yₛ [symbol] _{FAS} (7)
where yr and ys control the influence of texture and shape respectively on the final loss. This alignment of backbone features ensures that the earlier stages of RIN are more shape-aware in the representation space. Therefore, the feature alignment captures the generic feature representations that are unaffected by changes in color schemes, perturbations, and backgrounds.

The decision alignment, LDA, is employed to align the decision boundary of RIN and SIN. Enhancing the decision boundary of RIN with SIN forces RIN to utilize shape information for classification. Hence, LDA forces RIN to be less susceptible to learning from the shortcut cues in the data such as color schemes and background information. The bi-directionality in decision alignment incorporates Kullback-Leibler divergence individually for each component as given in Equation 8 and Equation 9.

[symbol]

_{DAR}= [symbol] _{KL}(σ( [symbol] (x))∥stopgrad(σ(S(h(x)))) (8)

[symbol]

_{DAS}= [symbol] _{KL}(stopgrad(σ(R(x)))∥σ(S(h(x))) (9)

[symbol]

_{DA}=λᵣ [symbol] _{DAR}+λₛ [symbol] _{DAS} (10)

where R(x) and S(h(x)) are the output logits from RIN and SIN, respectively, σ is softmax operator, λr and λs control the influence of distilling shape to RIN and texture to SIN, respectively. Therefore, decision alignment reduces the vulnerability of RIN to learning from superficial cues.

LCER and LCES are the cross-entropy loss for classifying the input images by RIN and SIN, respectively. This standard supervision loss improves the generalization of both the networks. The overall loss for training shape-aware FSL model using LSFSL is given by,

[symbol]

= [symbol] _{CER}+ [symbol] _{CES}+ [symbol] _{DA}+ [symbol] _{FA} (11)

The alignment loss factors are dynamically weighted depending on the training epoch and the alignment type. The meta-testing phase utilizes only the shape-aware RIN model that aggregated shape information in addition to other inductive biases. This type of training is a generic procedure and extendable to both meta or non-meta learning-based models.

The computer-implemented method of the current invention, LSFSL-Simple, is clearly illustrated in Algorithm 1. The model trained using Algorithm 1 can be enhanced using sequential knowledge distillation [7] (Algorithm 2) or online self-distillation [19] (Algorithm 3).

| Algorithm 1 LSFSL-Simple: Stage 1 Training Algorithm | |
|---|---|
| Input: dataset [symbol] , randomly initialized RIN model [symbol] | |
| with feature extractor ƒ_{Φ} and classifier g_{⊖}, randomly | |
| initialized SIN model S with feature extractor ƒ_{ϕ} and | |
| classifier g_{ω}, epochs E, softmax operator σ, stopgrad | |
| operator SG, cross-entropy loss CE, Kullback-Leibler | |
| divergence loss KLD, mean square error MSE, Sobel | |
| edge operator h, feature alignment loss factors (γᵣ, γᵣ) , | |
| decision alignment loss factors (λᵣ, λₛ) | |
| 1: for epoch e ∈ {1, 2, .., E) do | |
| 2: sample a mini-batch (x, y) ~ [symbol] | |
| 3: xₛₕₐₚₑ = h(x) | |
| 4: z_{Φ} = ƒ_{Φ}(x) | |
| 5: z_{ϕ} = ƒ_{ϕ}(xₛₕₐₚₑ) | |
| 6: [symbol] (x) = g_{⊖}(ƒ_{Φ}(x)) | |
| 7: S(h(x)) = g_{ω}(ƒ_{Φ}(h(xₛₕₐₚₑ))) | |
| 8: [symbol] _{CER} = CE(σ( [symbol] (x)), y) | |
| 9: [symbol] _{CES} = CE(σ(S(h(x))), y) | |
| 10: [symbol] _{FAR} = MSE(z_{Φ}, SG(z_{ϕ})) | [symbol] (Eq. 5) |
| 11: [symbol] _{FAS} = MSE(SG(z_{Φ}), z_{ϕ})) | [symbol] (Eq. 6) |
| 12: [symbol] _{FA} = γᵣ [symbol] _{FAR} + γₛ [symbol] _{FAS} | [symbol] (Eq. 7) |
| 13: [symbol] _{DAR} = KLD(σ( [symbol] (x))), SG(σ(S(h(x)))) | [symbol] (Eq. 8) |
| 14: [symbol] _{DAS} = KLD(SG(σ( [symbol] (x))), (σ(S(h(x)))) | [symbol] (Eq. 9) |
| 15: [symbol] _{DAS} = λᵣ [symbol] _{DAR} + λₛ [symbol] _{DAS} | [symbol] (Eq. 10) |
| 16: [symbol] = [symbol] _{CER} + [symbol] _{CES} + [symbol] _{FA} + [symbol] _{DA} | [symbol] (Eq. 11) |

17: Update parameters of [symbol] and S based on [symbol] using Stochas-
tic Gradient Descent (SGD)
18: end for
19: return RIN model

[symbol]

```
Algorithm 2 LSFSL-Distill: Stage 2 Training Algorithm
    Input: dataset [symbol]  , stage 1 trained and fixed RIN model
    Rₜ with feature extractor ƒₜ and classifier gₜ, randomly
    initialized student RIN model Rₛ with feature extrac-
    for ƒₜ and classifier gₜ, epochs E, softmax operator σ,
    cross-entropy loss CE, Kullback-Leibler divergence
    loss KLD, cross-entropy loss factor α, teacher-student
    decision alignment loss factor β
  1: for epoch e ∈ {1, 2, .., E} do
  2: sample a mini-batch (x, y) ~ [symbol]
  3: [symbol]   ₜ(x) = gₜ(ƒₜ(x))
  4: [symbol]   ₛ(x) = gₛ(ƒₛ(x))
  5: [symbol]   _{CE} = CE( [symbol]  ₛ(x), y)
  6: [symbol]   _{DA} = KLD( [symbol]  ₜ(x), [symbol]  ₛ(x))
  7: [symbol]    = α [symbol]  _{CE} + [symbol]   _{DA}
  8: Update parameters of [symbol]  ₛ based on [symbol]   using Stochas-
    tic Gradient Descent (SGD)
  9: end for
10: return RIN student model [symbol]   ₛ
```

| Algorithm 3 LSFSL-Online: Training Algorithm | |
|---|---|
| input: dataset [symbol] , randomly initialized RIN model [symbol] | |
| with feature extractor ƒ_{Φ} and classifier g_{⊖}, randomly | |
| initialized SIN model S with feature extractor ƒ_{ϕ} and | |
| classifier g_{ω}, randomly initialized and fixed teacher RIN | |
| model [symbol] ₜ with feature extractor ƒ_{t,Φ} and classifier g_{t,⊖}, | |
| epochs E, softmax operator σ, stopgrad operator SG, | |
| cross-entropy loss CE, Kullback-Leibler divergence | |
| loss KLD, mean square error MSE, Sobel edge opera- | |
| tor h, feature alignment loss factors (γᵣ, γᵣ), decision | |
| alignment loss factors (λᵣ, λₛ), teacher-student decision | |
| alignment loss factor β | |
| 1: for epoch e ∈ {1, 2, .., E} do | |
| 2: sample a mini-batch (x, y) ~ [symbol] | |
| 3: xₛₕₐₚₑ = h (x) | |
| 4: z_{Φ} = ƒ_{Φ}(x) | |
| 5: z_{ϕ} = ƒ_{ϕ}(xₛₕₐₚₑ) | |
| 6: [symbol] (x) = g_{⊖}(ƒ_{Φ}(x)) | |
| 7: S(h(x)) = g_{ω}(ƒ_{Φ}(h(xₛₕₐₚₑ))) | |
| 8: [symbol] ₜ(x) = g_{t,⊖}(ƒ_{t,Φ}(x)) | |
| 9: [symbol] _{CER} = CE(σ( [symbol] (x)), y) | |
| 10: [symbol] _{CES} = CE(σ(S(h(x))), y) | |
| 11: [symbol] _{FAR} = MSE(z_{Φ}, SG(z_{ϕ})) | [symbol] (Eq. 5) |
| 12: [symbol] _{FAS} = MSE(SG(z_{Φ}), z_{ϕ}) | [symbol] (Eq. 6) |
| 13: [symbol] _{FA} = γᵣ [symbol] _{rFAR} + γₛ [symbol] _{FAS} | [symbol] (Eq. 7) |
| 14: [symbol] _{DAR} = KLD(σ( [symbol] (x))), SG(σ(S(h(x)))) | [symbol] (Eq. 8) |
| 15: [symbol] _{DAS} = KLD(SG(σ( [symbol] (x))), σ(S(h(x)))) | [symbol] (Eq. 9) |
| 16: [symbol] _{DAS} = λᵣ [symbol] _{DAR} + λₛ [symbol] _{DAS} | [symbol] (Eq. 10) |

17: [symbol] _{TS} = KLD(σ( [symbol] (x)), σ( [symbol] ₜ(x)))
18: [symbol] = [symbol] _{CER} + [symbol] _{CES} + [symbol] _{FA} + [symbol] _{DA} + β [symbol] _{TS}
19: Update parameters of [symbol] and S based on [symbol] using Stochas-
tic Gradient Descent
20: Update [symbol] ₜ as EMA of [symbol]
21: end for
22: return RIN student model

[symbol]

Embodiments of the present invention can include every combination of features that are disclosed herein independently from each other.

Typical application areas of the invention include, but are not limited to:
Road condition monitoring
Road signs detection
Parking occupancy detection
Defect inspection in manufacturing
Insect detection in agriculture
Aerial survey and imaging

Although the invention has been discussed in the foregoing with reference to an exemplary embodiment of the method of the invention, the invention is not restricted to this particular embodiment which can be varied in many ways without departing from the invention. The discussed exemplary embodiment shall therefore not be used to construe the append-ed claims strictly in accordance therewith. On the contrary the embodiment is merely intended to explain the wording of the appended claims without intent to limit the claims to this exemplary embodiment. The scope of protection of the invention shall therefore be construed in accordance with the appended claims only, wherein a possible ambiguity in the wording of the claims shall be resolved using this exemplary embodiment.

Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another.

Optionally, embodiments of the present invention can include a general or specific purpose computer or distributed system programmed with computer software implementing steps described above, which computer software may be in any appropriate computer language, including but not limited to C++, FORTRAN, ALGOL, BASIC, Java, Python, Linux, assembly language, microcode, distributed programming languages, etc. The apparatus may also include a plurality of such computers/distributed systems (e.g., connected over the Internet and/or one or more intranets) in a variety of hardware implementations. For example, data processing can be performed by an appropriately programmed microprocessor, computing cloud, Application Specific Integrated Circuit (ASIC), Field Programmable Gate Array (FPGA), or the like, in conjunction with appropriate memory, network, and bus elements. One or more processors and/or microcontrollers can operate via instructions of the computer code and the software is preferably stored on one or more tangible non-transitive memory-storage devices.

### REFERENCES

1. R. Geirhos, P. Rubisch, C. Michaelis, M. Bethge, F. A. Wichmann, and W. Brendel. Imagenet trained cnns are biased towards texture; increasing shape bias improves accuracy and robustness. In International Conference on Learning Representations (ICLR). OpenReview.net, 2019. URL 220 https://openreview.net/forum?id=Bygh9j09KX.
2. R. Tao, H. Zhang, Y. Zheng, and M. Sawides. Powering Finetuning for Few-shot Learning: Domain-Agnostic Bias Reduction with Selected Sampling. Association for the Advancement of Artificial Intelligence (AAAI), 2022. URL https://arxiv.org/abs/2204.03749.
3. S. Ringer, W. Williams, T. Ash, R. Francis, and D. MacLeod. Texture Bias Of CNNs Limits Few-Shot Classification Performance. CoRR, abs/1910.08519, 2019. URL http://arxiv.org/abs/1910.08519.
4. X. Luo, L. Wei, L. Wen, J. Yang, L. Xie, Z. Xu, and Q. Tian. Rectifying the Shortcut Learning of Background: Shared Object Concentration for Few-Shot Image Recognition. CoRR, abs/2107.07746, 2021. URL https://arxiv.org/abs/2107.07746.
5. S. Stojanov, A. Thai, and J. M. Rehg. Using Shape To Categorize: Low-Shot Learning With an Explicit Shape Bias. In IEEE Conference on Computer Vision and Pattern Recognition (CVPR), pages 1798-1808. Computer Vision Foundation/IEEE, 2021. URL https://doi.org/10.1109/CVPR46437.2021.00184.
6. M. N. Rizve, S. H. Khan, F. S. Khan, and M. Shah. Exploring Complementary Strengths of Invariant and Equivariant Representations for Few-Shot Learning. In IEEE Conference on Computer Vision and Pattern Recognition (CVPR), pages 10836-10846. Computer Vision Foundation/IEEE, 2021.URL https://doi.org/10.1109/CVPR46437.2021.01069.
7. Y. Tian, Y. Wang, D. Krishnan, J. B. Tenenbaum, and P. Isola. Rethinking Few-Shot Image Classification: A Good Embedding is All You Need? In A. Vedaldi, H. Bischof, T. Brox, and J. Frahm, editors, European Conference in Computer Vision (ECCV), volume 12359 of Lecture Notes in Computer Science, pages 266-282. Springer, 2020. URL https://doi.org/10.1007/978-3-030-58568-6_16.
8. Y. Wang, W. Chao, K. Q. Weinberger, and L. van der Maaten. Simpleshot: Revisiting nearest neighbor classification for few-shot learning. CoRR, abs/1911.04623, 2019. URL http://arvix.org/abs/1911.04623.
9. Y. Wang, Q. Yao, J. T. Kwok, and L. M. Ni. Generalizing from a Few Examples: A Survey on Few-shot Learning. ACM Comput. Surv., 53(3):63:1-63:34, 2020. URL https://doi.org/10.1145/3386252.
10. Y. Song, T. Wang, S. K. Mondal, and J. P. Sahoo. A Comprehensive Survey of Few-shot Learning: Evolution, Applications, Challenges, and Opportunities. CoRR, abs/2205.06743, 2022. URL https://doi.org/10.48550/arXiv.2205.06743.
11. B. Landau, L. B. Smith, and S. S. Jones. The importance of shape in early lexical learning. Cognitive Development, 3(3):299-321, 1988. ISSN 0885-2014. URL https://doi.org/10.1016/0885-2014(88)90014-7.
12. G. Diesendruck and P. Bloom. How specific is the shape bias? Child development, 74:168-78, 02 2003. URL https://doi.org/10.1111/1467-8624.00528.
13. C. Finn, P. Abbeel, and S. Levine. Model-Agnostic Meta-Learning for Fast Adaptation of Deep Networks. In D. Precup and Y. W. Teh, editors, International Conference on Machine Learning (ICML), volume 70 of Proceedings of Machine Learning Research, pages 1126-1135. PMLR, 2017. URL http://proceedings.mlr.press/v70/finn17a.html.
14. S. Beaulieu, L. Frati, T. Miconi, J. Lehman, K. O. Stanley, J. Clune, and N. Cheney. Learning to Continually Learn. In G. D. Giacomo, A. Catalá, B. Dilkina, M. Milano, S. Barro, A. Bugarin, and J. Lang, editors, European Conference on Artificial Intelligence (ECAI 2020)-Conference on Prestigious Applications of Artificial Intelligence (PAIS 2020), volume 325 of Frontiers in Artificial Intelligence and Applications, pages 992-1001. IOS Press, 2020. URL https://doi.org/10.3233/FAIA200193.
15. S. Ravi and H. Larochelle. Optimization as a Model for Few-Shot Learning. In International Conference on Learning Representations (ICLR). OpenReview.net, 2017. URL https://openreview.net/forum?id=rJY0-KcII.
16. S. Baik, M. Choi, J. Choi, H. Kim, and K. M. Lee. Meta-Learning with Adaptive Hyperparameters. In H. Larochelle, M. Ranzato, R. Hadsell, M. Balcan, and H. Lin, editors, Neural Information Processing Systems (NeurIPS), 2020. URL https://proceedings.neurips.cc/paper/2020/hash/ee89223a2b625b5152132ed77abbcc79-Abstract.html.
17. B. Hariharan and R. B. Girshick. Low-Shot Visual Recognition by Shrinking and Hallucinating Features. In IEEE International Conference on Computer Vision (ICCV), pages 3037-3046. IEEE Computer Society, 2017. URL https://doi.org/10.1109/ICCV.2017.328.
18. M. Hou and I. Sato. A closer look at prototype classifier for few-shot image classification. CoRR, abs/2110.05076, 2021.URL https://andv.org/abs/2110.05076.
19. S. Liu and Y. Wang. Few-shot Learning with Online Self-Distillation. In IEEE/CVF International Conference on Computer Vision Workshops (ICCVW), pages 1067-1070. IEEE, 2021. URL https://doi.org/10.1109/ICCVW54120.2021.00124.
20. Shruthi Gowda, Bahram Zonooz, and Elahe Arani. InBiaseD: Inductive Bias Distillation to Improve Generalization and Robustness through Shape-awareness. arXiv preprint arXiv:2206.05846, 2022.

What is claimed is:

1. A computer-implemented method for capturing human-like object recognition in an artificial neural network, the method comprising the steps of:
training the network by splitting the network during training into two branches: a RGB image-based network (RIN)-branch, wherein the network receives a colored image as input; and a shape image-based network (SIN)-branch wherein the network receives a shape semantic-based image as input;
training the RIN-branch and the SIN-branch in parallel by calculating bias alignment losses for distilling shape information learned by the SIN-branch into the RIN-branch and for distilling texture information learned by the RIN-branch into the SIN-branch.

2. The computer-implemented method of claim 1 further comprising the step of obtaining the shape semantic-based image by using an edge detection algorithm on the colored image.

3. The computer-implemented method of claim 1 further comprising the step of providing the colored image as an RGB-based image.

4. The computer-implemented method of claim 1 further comprising the steps of incorporating in the RIN-branch and in the SIN-branch a backbone network for feature extraction and a fully connected layer, after the backbone network, for performing classification.

5. The computer-implemented method of claim 1 further comprising the step of configuring the RIN-branch and the SIN-branch as feature extractor networks.

6. The computer-implemented method of claim 1 wherein the step of calculating bias alignment losses comprises calculating at least one feature alignment loss for distilling shape information learned by the SIN-branch into the RIN-branch and for distilling texture information learned by the RIN-branch into the SIN-branch.

7. The computer-implemented method of claim 6 wherein the step of calculating the at least one feature alignment loss comprises the step of calculating a mean squared error between weighted feature embeddings of the RIN-branch and weighted feature embeddings of the SIN-branch.

8. The computer-implemented method of claim 1 wherein the step of calculating bias alignment losses comprises the step of calculating at least one decision alignment loss for aligning decision boundaries of the RIN-branch and the SIN-branch.

9. The computer-implemented method of claim 8 wherein the step of calculating the at least one decision alignment loss comprises the step of calculating for each branch a relative entropy measure, such as a Kullback-Leibler divergence, between activation functions in outputs of the RIN-branch and activation functions in outputs of the SIN-branch.

10. The computer-implemented method of claim 9 wherein the step of calculating for each branch a relative entropy measure comprises the steps of:
weighting the relative entropy measure of the RIN-branch to control shape distilling from the SIN-branch into the RIN-branch; and
weighting the relative entropy measure of the SIN-branch to control texture distilling from the RIN-branch into the SIN-branch.

11. The computer-implemented method of claim 1 further comprising the steps of:
calculating a cross-entropy loss over output of the RIN-branch; and
calculating a cross-entropy loss over output of the SIN-branch.

12. The computer-implemented method of claim 1 further comprising a meta-test training phase comprises the step of fitting a logistic regression on the features of the RGB-image extracted from the RIN-branch and a cross entropy loss.

13. A computer-readable medium provided with a computer program, wherein when the computer program is loaded and executed by a computer, the computer program causes the computer to carry out the steps of the computer-implemented method according to claim 1.

14. An autonomous vehicle comprising a data processing system loaded with a computer program, wherein the program is arranged for causing the data processing system to carry out the steps of the computer-implemented method according to claim 1 for enabling the autonomous vehicle to continually identify and classify objects from an environment surrounding the autonomous vehicle.

15. The computer-implemented method of claim 2, wherein the edge detection algorithm is a Sobel edge operator.

16. The computer-implemented method of claim 5, wherein the feature extractor networks comprise ResNet12-based classifiers.
